(19) United States
(12) Patent Application Publication
(10) Pub. No.: US 2020/0273098 A1
(43) Pub. Date: Aug. 27, 2020

(54) Method and Apparatus for Integrating Loan Information and Real Estate Listing

(71) Applicant: Michael Marr, Atlanta, GA (US)

(72) Inventor: Michael Marr, Atlanta, GA (US)

(21) Appl. No.: 16/798,598

(22) Filed: Feb. 24, 2020

Related U.S. Application Data
(60) Provisional application No. 62/809,325, filed on Feb. 22, 2019.
(60) Provisional application No. 62/809,332, filed on Feb. 22, 2019.

(51) Int. Cl. G06Q 40/02; G06Q 50/16; G06Q 30/06

(52) U.S. Cl. CPC G06Q 40/025; G06Q 30/0643; G06Q 50/163

(57) ABSTRACT

In a system for facilitating real estate events between real estate transaction participants via a global computer network, a lender computer is in data communication with the global computer network and receives a loan pre-approval request from a buyer/borrower and generates an associated contact record. A loan officer computer is in data communication with the global computer network and is associated with the selected loan officer. The loan officer computer is programmed to receive the buyer/borrower contact record from the lender computer. A central server receives a copy of the buyer/borrower contact record and selects a real estate agent from a list of associated real estate agents. The central server generates real estate agent notifications indicating that the selected real estate agent is assigned to the buyer/borrower contact record and transmits the real estate agent notification to the selected real estate agent, the buyer/borrower and the selected loan officer.

### CROSS-REFERENCE TO RELATED APPLICATION(S)

This application claims the benefit of U.S. Provisional Patent Application Ser. No. 62/809,325, filed Feb. 22, 2019, and U.S. Provisional Patent Application Ser. No. 62/809,332, filed Feb. 22, 2019, the entirety of each of which is hereby incorporated herein by reference.

### BACKGROUND OF THE INVENTION

### 1. Field of the Invention

The present invention relates to relationship management systems and, more specifically, to a system for managing relationships between a loan officer, a real estate agent and a borrower/buyer.

### 2. Description of the Related Art

Numerous on-line mortgage lenders, including such companies as Quicken Loans, Lending Tree, etc., offer preapproval of borrowers for real estate loans. Typically, a potential buyer of real estate will seek preapproval of a loan up to a desired amount from a lender prior to beginning their search for a property to buy. Having a preapproval increases the buyer's confidence in purchasing a property and provides increased leverage in making a deal. Also, there is less risk to the seller as a result of entering into a deal when the buyer is preapproved.

When a potential buyer/borrower contacts a lender, the matter is assigned to a loan officer—also known as a “mortgage loan originator”—who is responsible for shepherding the borrower's application through the approval process and to participate in preparing the loan for closure. Additionally, loan officers work to originate new loans through contacting potential leads and acting as a personal interface between the lender and potential borrowers.

A buyer, once successfully preapproved for a loan, will usually contact a real estate agent in the buyer's region of interest. The agent will present properties of interest to the borrower and provide opportunities for the buyer to examine properties. Once the buyer has selected a property, the agent will also act as an interface to communicate offers from the buyer to the seller.

Frequently, however, the agent will offer different lending choices to the buyer other than the lender that preapproved the buyer. This can be for various reasons, including existing business or personal relationships. As a result, the time and expense incurred by the lender who preapproved the loan for the buyer will be wasted.

Therefore, there is a need for a system that maintains a relationship between a lender and a buyer through all phases of real estate transactions.

### SUMMARY OF THE INVENTION

The disadvantages of the prior art are overcome by the present invention which, in one aspect, is a system for facilitating real estate events between real estate transaction participants via a global computer network. A lender computer is in data communication with the global computer network and is associated with a lender. The lender computer is programmed to receive a loan pre-approval request from a buyer/borrower and to generate a buyer/borrower contact record associated therewith. The lender computer is also programmed to generate a loan officer assignment indicator regarding the buyer/borrower contact record and to transmit the loan officer assignment indicator to a selected loan officer. The lender computer is also programmed to generate an approval indication when the lender has pre-approved the loan pre-approval request. The lender computer is also programmed to add the assignment indicator and the pre-approval indication to the buyer/borrower contact record. A loan officer computer is in data communication with the global computer network and is associated with the selected loan officer. The loan officer computer is programmed to receive the buyer/borrower contact record from the lender computer. A real estate agent computer is in data communication with the global computer network. A central server is in data communication with the global computer network and is programmed also to receive a copy of the buyer/borrower contact record and to select a real estate agent from a list of real estate agents associated with the lender to be assigned to the buyer/borrower contact record. The central server is further programmed to generate a real estate agent notification indicating that the selected real estate agent has been assigned to the buyer/borrower contact record and to transmit the real estate agent notification to the selected real estate agent, the buyer/borrower and the selected loan officer.

In another aspect, the invention is a server system for facilitating real estate events between real estate transaction participants via a global computer network. A lender computer is in data communication with the global computer network and associated with a lender. The lender computer is programmed to receive a loan pre-approval request from a buyer/borrower and to generate a buyer/borrower contact record associated therewith. The lender computer is also programmed to generate a loan officer assignment indicator regarding the buyer/borrower contact record and to transmit the loan officer assignment indicator to a selected loan officer. The lender computer is also programmed to generate an approval indication when the lender has pre-approved the loan pre-approval request. The lender computer is also programmed to add the assignment indicator and the pre-approval indication to the buyer/borrower contact record. A loan officer computer is in data communication with the global computer network and is associated with the selected loan officer. The loan officer computer is programmed to receive the buyer/borrower contact record from the lender computer. A real estate agent computer is in data communication with the global computer network. A central server is in data communication with the global computer network, wherein the central server is further programmed to present a loan-officer specific multiple listing service web page to the buyer/borrower computer, in which the loan-officer specific multiple listing service web page presents a plurality of real estate listing links to the buyer/borrower computer. Each of the plurality of real estate listing links to pages provides information about a property that is for sale. When the buyer/borrower clicks on one of the plurality of real estate listing links, the central server sends a notice to both the real estate agent and the loan officer identifying the property associated with the real estate listing link selected by the buyer/borrower.

In yet another aspect, the invention is a real estate system for facilitating real estate events between real estate transaction participants via a global computer network. A lender computer is in data communication with the global computer network and is associated with a lender. The lender computer is programmed to receive a loan pre-approval request from a buyer/borrower and to generate a buyer/borrower contact record associated therewith. The lender computer is also programmed to generate a loan officer assignment indicator regarding the buyer/borrower contact record and to transmit the loan officer assignment indicator to a selected loan officer. The lender computer is also programmed to generate an approval indication when the lender has pre-approved the loan pre-approval request. The lender computer is also programmed to add the assignment indicator and the pre-approval indication to the buyer/borrower contact record. A loan officer computer is in data communication with the global computer network and is associated with the selected loan officer. The loan officer computer is programmed to receive the buyer/borrower contact record from the lender computer. A real estate agent computer is in data communication with the global computer network. A central server is in data communication with the global computer network and is programmed also to receive a copy of the buyer/borrower contact record and to select a real estate agent from a list of real estate agents associated with the lender to be assigned to the buyer/borrower contact record. The central server is further programmed to generate a real estate agent notification indicating that the selected real estate agent has been assigned to the buyer/borrower contact record and to transmit the real estate agent notification to the selected real estate agent, the buyer/borrower and the selected loan officer. The central server is further programmed to present a loan-officer specific multiple listing service web page to the buyer/borrower computer, in which the loan-officer specific multiple listing service web page presents a plurality of real estate listing links to the buyer/borrower computer. Each of the plurality of real estate listing links to pages provides information about a property that is for sale. When the buyer/borrower clicks on one of the plurality of real estate listing links, the central server sends a notice to both the real estate agent and the loan officer identifying the property associated with the real estate listing link selected by the buyer/borrower. The central server is further programmed to receive an input from the selected real estate agent indicating that the real estate agent has made contact with the buyer/borrower and to store a record of input in the buyer/borrower contact record. The loan-officer specific multiple listing service web page includes an offer button associated with at least one of the real estate listing links that indicates that the buyer/borrower desires to make an offer on the property associated with the real estate listing link selected by the buyer/borrower so that when the offer button is clicked, the central server will receive input from the buyer/borrower regarding an amount offered for the property. The central server is further programmed to notify the selected loan officer and the selected real estate agent when the buyer/borrower clicks on the offer button. When the buyer/borrower clicks on the offer button, the central server is programmed to receive a confirmation from the loan officer that the amount offered by the buyer/borrower has been pre-approved and to transmit to the selected real estate agent an indication that the amount offered has been pre-approved and that the selected is authorized to present a corresponding offer to a seller of the property.

These and other aspects of the invention will become apparent from the following description of the preferred embodiments taken in conjunction with the following drawings. As would be obvious to one skilled in the art, many variations and modifications of the invention may be effected without departing from the spirit and scope of the novel concepts of the disclosure.

### BRIEF DESCRIPTION OF THE FIGURES OF THE DRAWINGS

FIG. 1 is a schematic diagram showing portal interconnections in one embodiment of a system for integrating loan officer, the buyer and real estate agent information.

FIG. 2 is a schematic diagram showing steps taken in the embodiment shown in

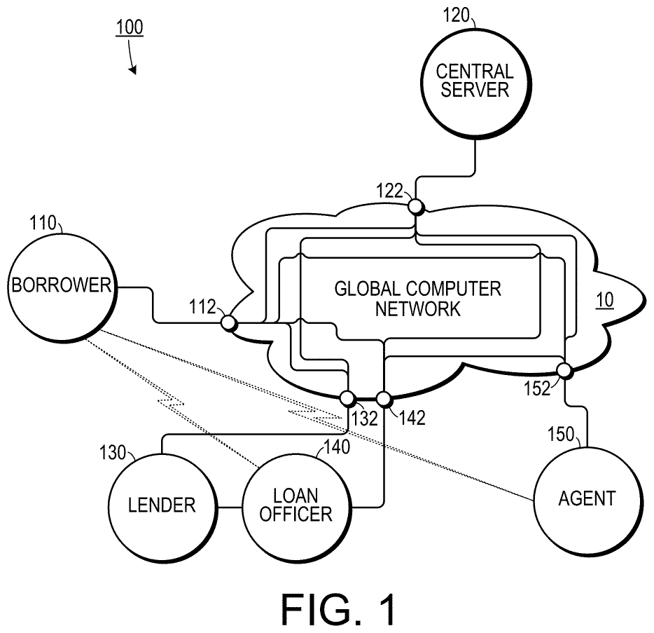

FIG. 1.

FIGS. 3A-3B are schematic diagrams of two lender-specific multiple listing service screens that are accessible with the embodiment shown in FIG. 1.

### DETAILED DESCRIPTION OF THE INVENTION

A preferred embodiment of the invention is now described in detail. Referring to the drawings, like numbers indicate like parts throughout the views. Unless otherwise specifically indicated in the disclosure that follows, the drawings are not necessarily drawn to scale. The present disclosure should in no way be limited to the exemplary implementations and techniques illustrated in the drawings and described below. As used in the description herein and throughout the claims, the following terms take the meanings explicitly associated herein, unless the context clearly dictates otherwise: the meaning of “a,” “an,” and “the” includes plural reference, the meaning of “in” includes “in” and “on.” Also, as used herein, “global computer network” includes the Internet.

As shown in FIG. 1, one representative embodiment of a system for integrating loan officer and real estate agent information involves an intercommunication system 100 between a borrower 110 (also referred to herein as “the buyer”), a central server 120, a lender 130, a loan officer 140 (which is typically an employee of, or otherwise affiliated with, the lender 130), and a real estate agent 150, all communicating with each other via the global computer network 10. The lines inside the image of the global computer network 10 represent the virtual connections between the different entities. The borrower 110 is in data communication via a borrower portal 112. The central server 120 is in data communication via a central server portal 122. The lender 130 is in data communication via a lender portal 132. The loan officer 140 is in data communication via a loan officer portal 142. The agent 150 is in data communication via an agent portal 152.

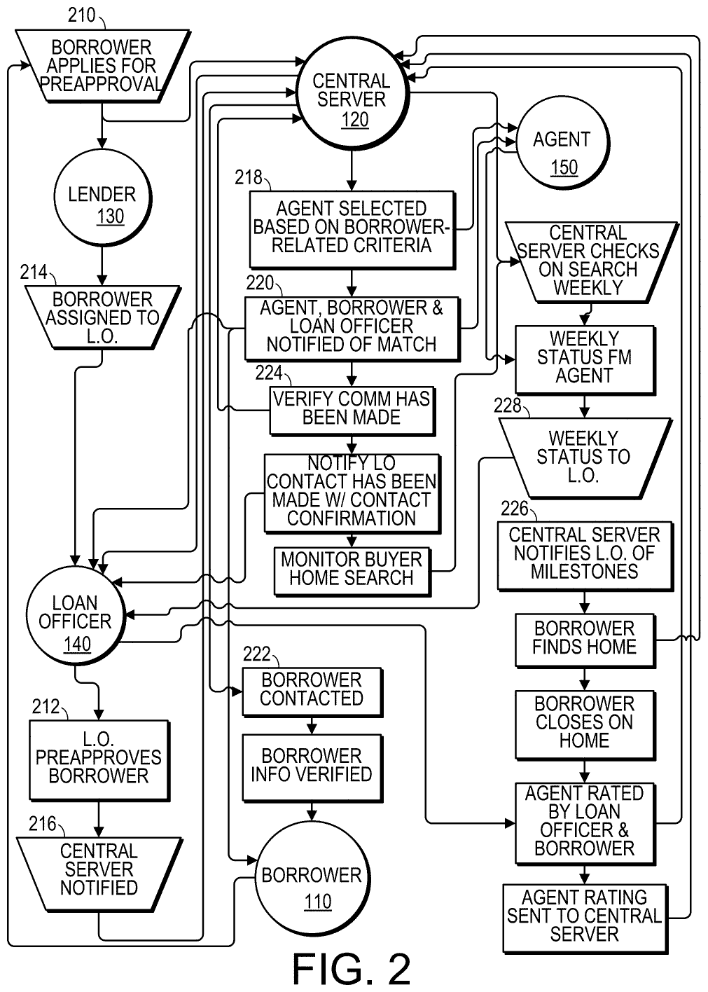

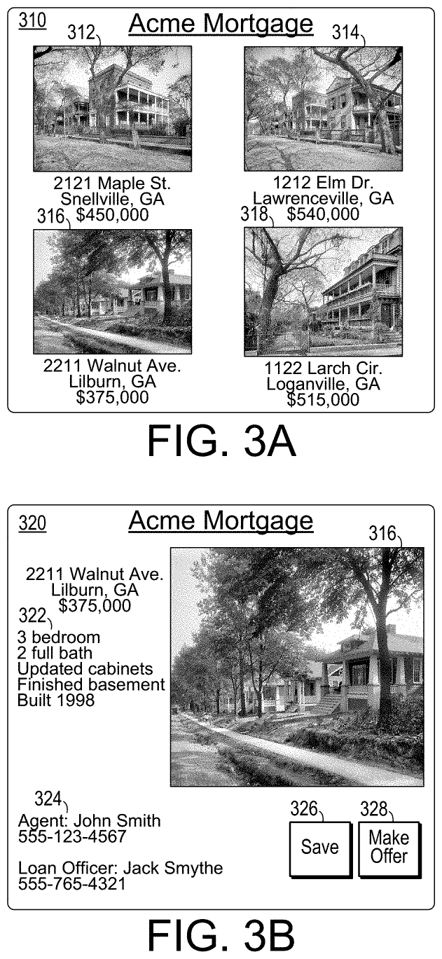

As shown in FIG. 2, when a borrower 110 applies 210 to a lender 130 for pre-approval of a home loan, the lender 130 executes a pre-approval process and, if the borrower 110 meets the pre-approval criteria, will pre-approve a loan 212. Once the loan is pre-approved, then the lender 130 notifies 216 the central server 120, which administers the system. The central server 120 will select an agent based on borrower-related criteria 218.

Typically, the system tries to pair an agent who is likely to be compatible with the borrower 110, based on the borrower's background and needs. For example, if the borrower is a retiree who is purchasing a retirement home, then the system might assign an older agent to the borrower. On the other hand, if the borrower is a military member who is moving due to reassignment, the system might assign a veteran to the borrower. Also, agents with higher success rates in closing deals might be given higher priority.

Once an agent is assigned, the central server 120 will send notifications 220 to the agent 150 and the loan officer 140 indicating that the agent 150 has been assigned to the borrower 110. This notification will include all relevant contact and other information. A text message 222 and an email will be sent to the borrower 110 with an introduction to the agent 150 and the agent's contact information.

Shortly thereafter, the agent 150 attempts to make a first contact 224 with the borrower 110. The results of this attempt are reported to the central server 120. For example, the results could indicate that the contact was made or they could indicate that the borrower 110 did not respond. Similarly, they could indicate that the borrower 110 is not currently seeking to purchase a home. Such results are stored and presented to the loan officer 140.

Once the agent 150 succeeds in contacting the borrower 110, the central server 120 reminds the loan officer to contact the borrower 110 at several critical milestones 226 and also issues weekly status updates 228 to the agent 150 and the loan officer 140 in real time. While notification of new loan pre-approval is typically done automatically by the lender, the information can also be entered on a manual input screen.

The central server receives a copy of the buyer/borrower contact record and selects a real estate agent from a list of real estate agents associated with the lender to be assigned to the buyer/borrower contact record. The central server also generates a real estate agent notification indicating that the selected real estate agent has been assigned to the buyer/borrower contact record and transmits the real estate agent notification to the selected real estate agent, the buyer/borrower and the selected loan officer. The central server receives inputs from the real estate agent indicating that the real estate agent has made contact with the buyer/borrower and to stores a record of input in the buyer/borrower contact record.

The central server receives buyer/borrower status reports from the selected agent. The buyer/borrower status reports indicate completion of events relevant to a property search by the buyer/borrower. The central server also transmits the buyer/borrower status report to the loan officer. The central server monitors events involving a property search by the buyer/borrower and sends periodic reports to the loan officer and the real estate agent indicative of the events. The central server transmits indications of important property buying related milestone dates to the loan officer and the real estate agent. The central server also receives indications from the buyer/borrower that the buyer/borrower has closed on a property and transmits an indication thereof to the loan officer and the real estate agent.

In one commercial embodiment, when lenders or loan officers pre-approve a borrower for a home loan, they will request a real estate agent through a proprietary application programming interface (API) if the borrower (or “future homeowner”) is in need of a real estate agent. The API can integrate with the lender existing Loan Origination System (LOS) and its Customer Relationship Management (CRM) system. (While in one embodiment, the CRM system is Salesforce CRM, it is understood that most other CRM systems can interface with the present invention.) The Loan officer submits a deal by triggering an API push from the LOS system (which could be in the form of a button or drop-down). The API push is sent to API's database on a central server. As a result, a new contract record is created for the borrower requesting an agent. For lenders without LOS system, a deal can be submitted via a fillable request form presented by the API. When an agent submits request through the site, it triggers an API push into the central database and a new contact record is created for the borrower requesting an agent.

In submitting a request, a lender can email the request to a central server. The request can include the buyer's contact information and other relevant information. An employee of the central service will then create the contact record manually in the central database. Alternatively, a lender can call a central telephone number to provide the information to the central service employee. The employee will then create the contact record manually in the central database. A lender can also live transfer a borrower to the central service employee directly via telephone. In this case, the employee will get the details directly from the borrower and will create the contact record manually.

Regarding the initial contact with the buyer (i.e., borrower), when the buyer's information is received the central service will immediately make a contact attempt with the buyer via call, text and email. This is pushed immediately when the lead is received. The first contact with the buyer can be a critical step to gain insight on the buyer's wants, needs and desires in the new home purchase, as well as capturing the deal prior to involvement by another lender. In addition, the first contact allows the central service to gain a better understanding on the buyer's personality profile. This can come in handy when selecting an agent who will have a high probability of creating an ideal initial connection with the buyer and form a good relationship.

In one commercial embodiment, the system includes a network of over 30,000 vetted and trained real estate agents. Each agent has been hand selected by realty advisors, based on predefined criteria. The agents are trained to handle preapproved buyers in a way that optimizes lender conversions. In this embodiment, each agent must have held a license for 3 years or more, must have closed a minimum of, for example, 15 transactions in the past two years, must have experience negotiating seller-paid closing cost and must be a full time agent. Also, the agents must agree and adhere to agent expectations, they must go through training before receipt of first deal from the system and they must sign master agreement to be a part of the network. Selection of agents for pairing with buyers is based on agent performance, conversion ratios and type of deals they have closed.

Once a deal is set up and an agent has been paired to the buyer, introductory/confirmation emails go out to all parties, including the borrower, the loan officer and the agent. In the emails to the agents, they are reminded about the system's standards. Follow-up emails are sent on a weekly basis. The lending officers are also updated via email and their portal at each milestone and periodically every week. This allows the lending officers to work on originating leads while the system manages their preapproved borrowers. The system converts more deals through: heavy follow up, an open line of communication to loan officers, constant follow up to the buyer and real time updates. In this embodiment, the back-end portal (from the central server) can push notifications to the relevant parties.

Certain events trigger specific notifications. For example, when a deal is paired, the following notifications are sent: the real estate agent's contact information is sent to loan officer, the buyer's contact information is sent to the agent, and the real estate agent's contact information is sent to the buyer. Once the agent makes contact with the buyer, a notification goes to loan officer to inform it that the agent has made contact with the buyer. An alert is also sent to the loan officer if the agent cannot reach the buyer.

Also, a notification goes to loan officer when the buyer is placing an offer on a home or if the buyer is placing its home search on hold. If the buyer already has another agent, a notification goes to loan officer indicating that the buyer is working with another agent. A notification goes to the loan officer when buyer is under contract. Also, a notification goes to the loan officer when the buyer is no long looking for a home.

The system helps to ensure that agents do not purposefully introduce other outside lenders to the buyer. Also, loan officers are made aware of where the buyers are at during the entire home buying process. The loan officer portal loan allows officers to manage all of their deals from one central location. The loan officer can also view in real time status of all online activity of the buyer while it is shopping online. Additionally, the loan officer and the agent are able to communicate in one central location.

Changes in buyer's status will be pushed to the loan officer via text, email and alerts through the app. Buyer's favorite properties will also be pushed to the loan officer via text, email and alerts through the app.

In selecting an agent, the system looks closely at the buyer's persona and agent similarities in order to ensure that the buyer and the agent will have a good match and will work well together. When a buyer and an agent have high compatibility rates, the likeliness that buyer will stay with the agent will increase.

After every deal the agents are rated by both the loan officer and the buyer as part of rating the agent's standings in network. In order to keep good standings in the network, the agents must keep a minimum rating in the network. If a loan officer or buyer complains about an agent the agent may be removed from the network.

To ensure that the buyer is being taken care of, the system employs a comprehensive follow up process. For example, after deal has been paired, the system follows up with both the agent and buyer after two hours to ensure that contact has been made. If the agent is unable to make contact with the buyer, the system informs the loan officer that it has been unable to make contact. The loan officer can use this information as a trigger to re-engage the buyer. Also, when the agent has made contact, the system informs the loan officer of the contact.

The system will send out emails weekly to check in with the status of the buyer's home buying journey. The system will make contact with either the agent or the buyer (or both) to get status updates. Periodically (e.g., every Friday), the system will send a mass update to all loan officers that have active deals with the system so that they can get an update on their deals. The system will also follow up on hold deals on a weekly basis to move them out of hold status and back to active status. The system can also rank deals (e.g., as “hot,” “warm,” “cold” of “dead”) to make the managing of deals more efficient.

As shown in FIGS. 3A and 3B, one embodiment employs a nationwide multiple listing service (MLS) platform that has two channels for business: one that is consumer facing and the other that is lender facing. The buyer is able to search for a home through a portal to the MLS. While searching, the buyer can designate favorite homes and favorite properties. The loan officer and the agent can then be notified of the buyer's favorites. As shown in FIG. 3A, an initial MLS page 310 can include photographs and information about several different properties (312, 314, 316 and 318). If a buyer/borrower clicks on one of the properties (for example, property 316) then the server will present a property-specific screen 320, as shown in FIG. 3B. Screen 320 can provide additional information 322 about the selected property 316 and information 324 about the real estate agent and the loan officer. Additionally, in can include a favorite button 326 that saves the property in a list for later viewing by the buyer/borrower. The central server notifies the real estate agent and the loan officer of the saved property when the buyer/borrower clicks button 326. If the buyer/borrower decides to make an offer on the property, then a “make offer” button 328 is clicked. This will cause an input window to appear by which the buyer/borrower inputs details about the offer (e.g., the offered price and any other conditions that the buyer/borrower wants to include in the offer). The central server will transmit this information to the lender and the loan officer to get a pre-approval confirmation. If such confirmation is issued by the lender, then the central server notifies the real estate agent that the agent is authorized to present the offer to the seller.

The MLS platform is branded individually for the lenders that the system works with and can be branded to a specific individual loan officer working for the lender. When the buyer registers its email address with the system, the system sends a message to the central database, which results in the loan officer being notified that the preapproved buyer is actively searching for a property. In a situation in which the deal is referred directly by the loan officer, the system will assign the buyer to the loan officer manually. Once the relationship is established, the buyer can message the loan officer directly through the portal.

Any buyer activity on the MLS platform is pushed in real time to the loan officer via, email, text, and the loan officer's portal and to the agent's portal. Specifically, listings of the properties designated by the buyer as favorites are pushed to the loan officer. The loan officer portal allows loan officers to manage all of their deals in one central location. The system allows the loan officer to view in the status of all online activity of the buyer while shopping online in real time. Also, the system also allows the loan officer to communicate with the agent in one central (virtual) location through a two-way communication chatter window.

Additionally, when buyers search for a home online, the system allows them to place an instant offer on the home. When they select the instant offer option, they will be prompted to fill out standard offer fields, including: the offer price; their requested close date; desired seller concessions; and indication of whether they need to sale another home first; and an indication of whether they are pre-approved to purchase at the offered price. Once the buyer fills out the offer fields, they will sign the form using an e-signature, which results in the offer being submitted to the system. Once the offer has been submitted, it will go to the loan officer to ensure the buyer is preapproved for offer amount. Once offer has been approved by lender, the system will forward the offer to an agent who is approved and listed by the system, who will then submit the offer to the seller. Once the offer has been submitted, the buyer is brought into the property within 24 hours to ensure the home meets its expectations.

Although specific advantages have been enumerated above, various embodiments may include some, none, or all of the enumerated advantages. Other technical advantages may become readily apparent to one of ordinary skill in the art after review of the following figures and description. It is understood that, although exemplary embodiments are illustrated in the figures and described below, the principles of the present disclosure may be implemented using any number of techniques, whether currently known or not. Modifications, additions, or omissions may be made to the systems, apparatuses, and methods described herein without departing from the scope of the invention. The components of the systems and apparatuses may be integrated or separated. The operations of the systems and apparatuses disclosed herein may be performed by more, fewer, or other components and the methods described may include more, fewer, or other steps. Additionally, steps may be performed in any suitable order. As used in this document, “each” refers to each member of a set or each member of a subset of a set. It is intended that the claims and claim elements recited below do not invoke 35 U.S.C. § 112(f) unless the words “means for” or “step for” are explicitly used in the particular claim. The above described embodiments, while including the preferred embodiment and the best mode of the invention known to the inventor at the time of filing, are given as illustrative examples only. It will be readily appreciated that many deviations may be made from the specific embodiments disclosed in this specification without departing from the spirit and scope of the invention. Accordingly, the scope of the invention is to be determined by the claims below rather than being limited to the specifically described embodiments above.

What is claimed is:

1. A system for facilitating real estate events between real estate transaction participants via a global computer network, comprising:
(a) a lender computer in data communication with the global computer network and associated with a lender, programmed to receive a loan pre-approval request from a buyer/borrower and to generate a buyer/borrower contact record associated therewith, the lender computer also programmed to generate a loan officer assignment indicator regarding the buyer/borrower contact record and to transmit the loan officer assignment indicator to a selected loan officer, the lender computer also programmed to generate an approval indication when the lender has pre-approved the loan pre-approval request, the lender computer also programmed to add the assignment indicator and the pre-approval indication to the buyer/borrower contact record;
(b) a loan officer computer in data communication with the global computer network and associated with the selected loan officer, the loan officer computer programmed to receive the buyer/borrower contact record from the lender computer;
(c) a real estate agent computer in data communication with the global computer network; and
(d) a central server in data communication with the global computer network and programmed also to receive a copy of the buyer/borrower contact record and to select a real estate agent from a list of real estate agents associated with the lender to be assigned to the buyer/borrower contact record, the central server further programmed to generate a real estate agent notification indicating that the selected real estate agent has been assigned to the buyer/borrower contact record and transmit the real estate agent notification to the selected real estate agent, the buyer/borrower and the selected loan officer.

2. The system of claim 10, wherein the central server is further programmed to receive an input from the selected real estate agent indicating that the real estate agent has made contact with the buyer/borrower and to store a record of input in the buyer/borrower contact record.

3. The system of claim 10, wherein the central server is further programmed to receive a buyer/borrower status report from the selected agent, wherein the buyer/borrower status report indicates completion of events relevant to a property search by the buyer/borrower and wherein the central server is further programmed to transmit the buyer/borrower status report to the selected loan officer.

4. The system of claim 10, wherein the central server is further programmed to monitor events involving a property search by the buyer/borrower and send periodic reports to the selected loan officer and the selected real estate agent indicative of the events.

5. The system of claim 10, wherein the central server is further programmed to transmit indications of important property buying related milestone dates to the selected loan officer and the selected real estate agent.

6. The system of claim 10, wherein the central server is further programmed to receive an indication from the buyer/borrower that the buyer/borrower has closed on a property and to transmit an indication thereof to the selected loan officer and the selected real estate agent.

7. The system of claim 1, wherein the central server is further programmed to present a loan-officer specific multiple listing service web page to the buyer/borrower computer, in which the loan-officer specific multiple listing service web page presents a plurality of real estate listing links to the buyer/borrower computer, each of the plurality of real estate listing links to pages providing information about a property that is for sale, wherein when the buyer/borrower clicks on one of the plurality of real estate listing links, the central server sends a notice to both the real estate agent and the loan officer identifying the property associated with the real estate listing link selected by the buyer/borrower.

8. The system of claim 7, wherein the loan-officer specific multiple listing service web page includes an offer button associated with at least one of the real estate listing links that indicates that the buyer/borrower desires to make an offer on the property associated with the real estate listing link selected by the buyer/borrower so that when the offer button is clicked, the central server will receive input from the buyer/borrower regarding an amount offered for the property, wherein the central server is further programmed to notify the selected loan officer and the selected real estate agent when the buyer/borrower clicks on the offer button.

9. The system of claim 8, wherein, when the buyer/borrower clicks on the offer button, the central server is programmed to receive a confirmation from the loan officer that the amount offered by the buyer/borrower has been pre-approved and to transmit to the selected real estate agent an indication that the amount offered has been pre-approved and that the selected is authorized to present a corresponding offer to a seller of the property.

10. A server system for facilitating real estate events between real estate transaction participants via a global computer network, comprising:
(a) a lender computer in data communication with the global computer network and associated with a lender, programmed to receive a loan pre-approval request from a buyer/borrower and to generate a buyer/borrower contact record associated therewith, the lender computer also programmed to generate a loan officer assignment indicator regarding the buyer/borrower contact record and to transmit the loan officer assignment indicator to a selected loan officer, the lender computer also programmed to generate an approval indication when the lender has pre-approved the loan pre-approval request, the lender computer also programmed to add the assignment indicator and the pre-approval indication to the buyer/borrower contact record;
(b) a loan officer computer in data communication with the global computer network and associated with the selected loan officer, the loan officer computer programmed to receive the buyer/borrower contact record from the lender computer;
(c) a real estate agent computer in data communication with the global computer network; and
(d) a central server in data communication with the global computer network, wherein the central server is further programmed to present a loan-officer specific multiple listing service web page to the buyer/borrower computer, in which the loan-officer specific multiple listing service web page presents a plurality of real estate listing links to the buyer/borrower, each of the plurality of real estate listing links to pages providing information about a property that is for sale, wherein when the buyer/borrower clicks on one of the plurality of real estate listing links, the central server sends a notice to both the real estate agent and the loan officer identifying the property associated with the real estate listing link selected by the buyer/borrower.

11. The server system of claim 10, wherein the loan-officer specific multiple listing service web page includes an offer button associated with at least one of the real estate listing links that indicates that the buyer/borrower desires to make an offer on the property associated with the real estate listing link selected by the buyer/borrower so that when the offer button is clicked, the central server will receive input from the buyer/borrower regarding an amount offered for the property, wherein the central server is further programmed to notify the selected loan officer and the selected real estate agent when the buyer/borrower clicks on the offer button.

12. The server system of claim 11, wherein, when the buyer/borrower clicks on the offer button, the central server is programmed to receive a confirmation from the loan officer that the amount offered by the buyer/borrower has been pre-approved and to transmit to the selected real estate agent an indication that the amount offered has been pre-approved and that the selected is authorized to present a corresponding offer to a seller of the property.

13. The server system of claim 10, wherein the central server is further programmed also to receive a copy of the buyer/borrower contact record and to select a real estate agent from a list of real estate agents associated with the lender to be assigned to the buyer/borrower contact record, the central server further programmed to generate a real estate agent notification indicating that the selected real estate agent has been assigned to the buyer/borrower contact record and transmit the real estate agent notification to the selected real estate agent, the buyer/borrower and the selected loan officer.

14. The system of claim 10, wherein the central server is further programmed to receive an input from the selected real estate agent indicating that the real estate agent has made contact with the buyer/borrower and to store a record of input in the buyer/borrower contact record.

15. The system of claim 10, wherein the central server is further programmed to receive a buyer/borrower status report from the selected agent, wherein the buyer/borrower status report indicates completion of events relevant to a property search by the buyer/borrower and wherein the central server is further programmed to transmit the buyer/borrower status report to the selected loan officer.

16. The system of claim 10, wherein the central server is further programmed to monitor events involving a property search by the buyer/borrower and send periodic reports to the selected loan officer and the selected real estate agent indicative of the events.

17. The system of claim 10, wherein the central server is further programmed to transmit indications of important property buying related milestone dates to the selected loan officer and the selected real estate agent.

18. The system of claim 10, wherein the central server is further programmed to receive an indication from the buyer/borrower that the buyer/borrower has closed on a property and to transmit an indication thereof to the selected loan officer and the selected real estate agent.

19. A real estate system for facilitating real estate events between real estate transaction participants via a global computer network, comprising:
(a) a lender computer in data communication with the global computer network and associated with a lender, programmed to receive a loan pre-approval request from a buyer/borrower and to generate a buyer/borrower contact record associated therewith, the lender computer also programmed to generate a loan officer assignment indicator regarding the buyer/borrower contact record and to transmit the loan officer assignment indicator to a selected loan officer, the lender computer also programmed to generate an approval indication when the lender has pre-approved the loan pre-approval request, the lender computer also programmed to add the assignment indicator and the pre-approval indication to the buyer/borrower contact record;
(b) a loan officer computer in data communication with the global computer network and associated with the selected loan officer, the loan officer computer programmed to receive the buyer/borrower contact record from the lender computer;
(c) a real estate agent computer in data communication with the global computer network; and
(d) a central server in data communication with the global computer network and programmed also to receive a copy of the buyer/borrower contact record and to select a real estate agent from a list of real estate agents associated with the lender to be assigned to the buyer/borrower contact record, the central server further programmed to generate a real estate agent notification indicating that the selected real estate agent has been assigned to the buyer/borrower contact record and transmit the real estate agent notification to the selected real estate agent, the buyer/borrower and the selected loan officer, the central server further programmed to present a loan-officer specific multiple listing service web page to the buyer/borrower computer, in which the loan-officer specific multiple listing service web page presents a plurality of real estate listing links to the buyer/borrower, each of the plurality of real estate listing links to pages providing information about a property that is for sale, wherein when the buyer/borrower clicks on one of the plurality of real estate listing links, the central server sends a notice to both the real estate agent and the loan officer identifying the property associated with the real estate listing link selected by the buyer/borrower wherein the central server is further programmed to receive an input from the selected real estate agent indicating that the real estate agent has made contact with the buyer/borrower and to store a record of input in the buyer/borrower contact record, wherein the loan-officer specific multiple listing service web page includes an offer button associated with at least one of the real estate listing links that indicates that the buyer/borrower desires to make an offer on the property associated with the real estate listing link selected by the buyer/borrower so that when the offer button is clicked, the central server will receive input from the buyer/borrower regarding an amount offered for the property, wherein the central server is further programmed to notify the selected loan officer and the selected real estate agent when the buyer/borrower clicks on the offer button and wherein, when the buyer/borrower clicks on the offer button, the central server is programmed to receive a confirmation from the loan officer that the amount offered by the buyer/borrower has been pre-approved and to transmit to the selected real estate agent an indication that the amount offered has been pre-approved and that the selected is authorized to present a corresponding offer to a seller of the property.

20. The real estate system of claim 19, wherein the central server is further programmed to receive a buyer/borrower status report from the selected agent, wherein the buyer/borrower status report indicates completion of events relevant to a property search by the buyer/borrower and wherein the central server is further programmed to transmit the buyer/borrower status report to the selected loan officer, and wherein the central server is further programmed to monitor events involving a property search by the buyer/borrower and send periodic reports to the selected loan officer and the selected real estate agent indicative of the events and wherein the central server is further programmed to transmit indications of important property buying related milestone dates to the selected loan officer and the selected real estate agent and wherein the central server is further programmed to receive an indication from the buyer/borrower that the buyer/borrower has closed on a property and to transmit an indication thereof to the selected loan officer and the selected real estate agent.
